(19) United States
(12) Patent Application Publication
(10) Pub. No.: US 2008/0012786 A1
(43) Pub. Date: Jan. 17, 2008

(54) Flexible antenna

(76) Inventor: Hsiu-Ling Yang, Tauyuan City (TW)

Correspondence Address: YANG, HSIU-LING, 20525 Via Talavera, Yorba Linda, CA, 92887, US

(21) Appl. No.: 11/486,195

(22) Filed: Jul. 14, 2006

(51) Int. Cl. H01Q 1/36

(52) U.S. Cl. 343/895

(57) ABSTRACT

The present invention provides a structure of flexible antenna comprising a flexible metal tube, and an insulating tube. The flexible metal tube can sustain to an external force without damaging to form a corresponding curvy shape, wherein one end of the flexible metal tube can be connected to a predetermined electronic device via a signal connector. The insulating tube covers an external surface of the flexible metal tube in order to insolate electrical connection between the flexible metal tube and an external conductors. The property of the flexible antenna of the present invention can sustain to external pressure or force and be deformed into a desired shape. This flexible antenna can be deformed into various designed shapes in accordance with different environmental conditions in order to fit the various space restrictions.

### BACKGROUND OF THE INVENTION

1. Field of Invention

The present invention relates to a flexible antenna. More particularly, the present invention relates to a flexible antenna that can be deformed to fit the transmitting signal requirements in various environmental conditions.

2. Description of the Related Art

The conventional structure of antenna for transmitting electromagnetic wave is normally integrated from simple components. For example, a multi-wire cable with an insulting surface and metal cores can be connected to an input end of a receiver or an output end of a transmitter. The metal cores that are sensitive for electromagnetic induction are utilized as the main role of forming an antenna structure. But the multi-wire cable does not exhibit sufficient rigidity to sustain its own weight. If the external support structure is absent, the multi-wire cable can only be connected to a transmitting device via a hanging method. The direction of the transmitting and receiving cannot be adjusted appropriately. Therefore, the overall transmission efficiency cannot be optimized.

Other antennas commonly used are antennas with fixed length or adjustable length. The antennas with fixed length are made from an elastic metal or carbon fibres and are formed as a stick-like structure with a fixed length, in order to utilize its sensitivity of electromagnetic induction to transmit electromagnetic wave. However, the antenna made from the elastic metal or carbon fibres with fixed length cannot be easily bent into deformed shapes and its transmitting direction cannot be controlled or adjusted freely. Therefore, the antenna with fixed length is used exclusively in the spacious environment, and its transmission efficiency is restricted.

The antenna with adjustable length is constructed with a plurality of metal tubes that are putted together layer by layer, wherein a stop portion is provided at an inner end of each of the metal tubes to prevent the metal tube at an outer layer from separating, thus, an adjustable structure is formed. A rotating connector is located at a base unit of the adjustable antenna so that its length can be adjustable, and the adjustable antenna can be rotated up to 360 degrees to adjust the transmitting direction. Although the adjustable antenna can be adjusted by varying its length, the stretching range of the antenna is limited due to the restriction of less spacious surrounding. When the adjustable antenna cannot be stretched to a desired extent, the quality and efficiency of the transmission would be poor. The objective of the present invention is to provide an improved structure of antenna that can overcome those defects.

### SUMMARY OF THE INVENTION

It is an object of the present invention to provide a flexible antenna which can sustain external force and form a corresponding bending shape in accordance with various space size needed in different environmental conditions.

The flexible antenna of the present invention comprises a flexible metal tube, and an insulating tube. The flexible metal tube can sustain to an external force without damaging to form a corresponding curvy shape, wherein one end of the flexible metal tube can be connected to a predetermined electronic device via a signal connector. The insulating tube covers an external surface of the flexible metal tube in order to avoid electrical connection between the flexible metal tube and an external conductors. The property of the flexible antenna of the present invention can sustain to external pressure or force and be deformed into a desired shape. This flexible antenna can be confined into various designed shapes in accordance with different environmental conditions in order to fit the various space restrictions.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is an assembly view of a structure of flexible antenna in accordance with a preferred example of the present invention;

FIG. 2 shows a schematic view of an assembled flexible antenna in accordance with the preferred example of the present invention;

FIG. 3 is a cross-sectional view of the assembled flexible antenna of FIG. 2;

FIG. 4 illustrates the flexible antenna of the present invention using on a wireless video device positioned on a rotating unit;

FIG. 5 shows the flexible antenna utilized on the signal connecting end (antenna) of the common radio 5;

FIG. 6 illustrates the flexible antenna utilized on the signal output of the wireless microphone.

### DESCRIPTION OF THE PREFERRED EMBODIMENTS

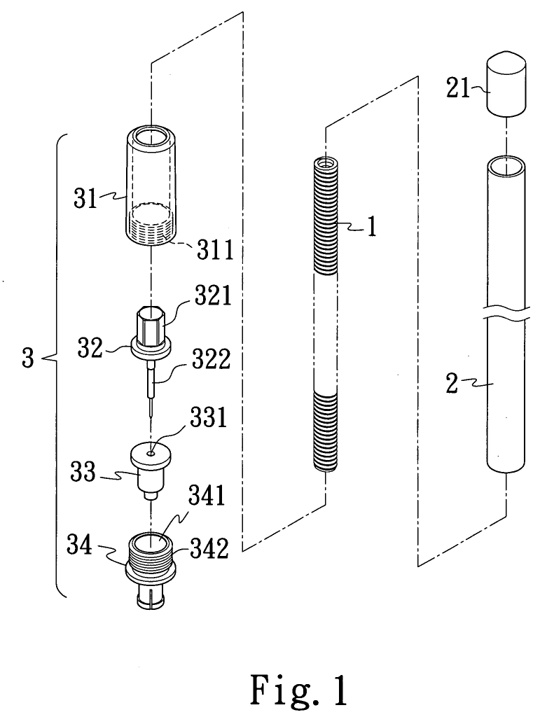

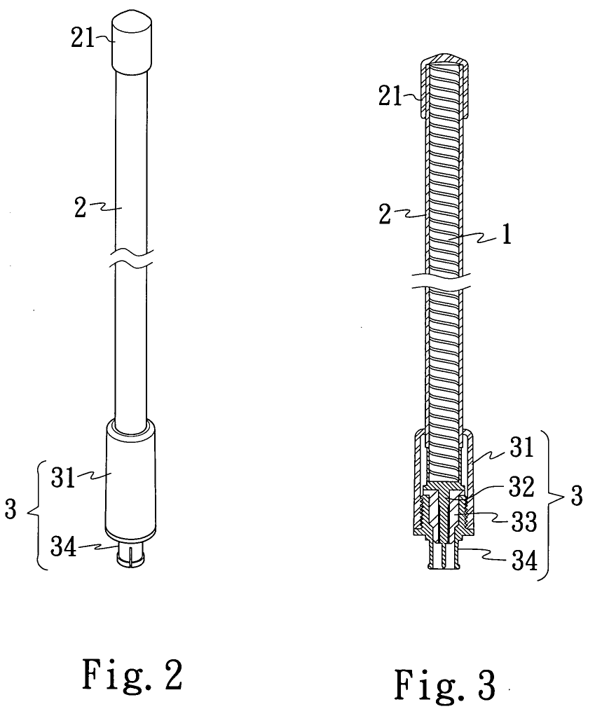

FIG. 1 illustrates an assembly view of a structure of flexible antenna in accordance with a preferred example of the present invention. FIG. 2 shows a schematic view of an assembled flexible antenna in accordance with the preferred example of the present invention, and FIG. 3 is a cross-sectional view of the assembled flexible antenna of FIG. 2. The present invention provides a flexible antenna comprising a metal tube 1, an insulating tube 2 and a signal connector 3, wherein a spring steel with high density spirals is utilized to confine the metal tube 1 to a hollow tube. However, the metal tube 1 of the present invention is not limited to the use of spring steels, other flexible units, such as a metal coil-shaped pipe or other similar objects can also be utilized to confine or roll up to form the shape of the metal tube 1. In other words, the material used must be springy, durable and can be subjected to an external force without alter its confined shape.

The insulating tube 2 is a heat shrinkable insulating tube, and its hollow centre can be used to slip onto the metal tube 1, and an insulating end cap 21 is covered one end of metal tube 1 in such that an insulating layer is formed on the external surface of the metal tube 1 in order to prevent any electrical connection between the metal tube 1 from the external conductors. The signal connector 3 is located at another end of the metal tube 1 that is opposite to the end covered with the insulating end cap 21. In other words, the insulating end cap 21 is provided on one end of the flexible metal tube, which is opposite to the end of the flexible metal tube with the signal connector. Although the preferred example of the present invention discloses the utilization of the insulating end cap 21, such as the signal connector for coaxial cable, however, the present invention is not limited to the usage of the signal connector of coaxial cable, other signal transmitting connectors can be utilized. The signal connector 3 comprises a metal end cap 31, a signal connecting device 32, an insulating base 33 and a ground end cap 34 assembled together, wherein a connecting head 321 and a signal pin 322 are provided respectively both ends of the signal connecting device 32. The connecting head 321 can be slipped onto an exposed portion of the insulating tube 2 which covers one end of the metal tube 1, and the metal end cap 31 can be slide over the signal connecting device 32 to cover a certain part of insulating tube 2 and the metal tube 1 as shown in FIGS. 2 and 3. Screw-line patterns 311 are formed circumstantially and internally at one end of the metal end cap 31. A central hole 331 is provided at a center part of the insulating base 33 in order for the signal pin 322 of the signal connecting device 32 to pass through, and a locating space 341 is also provided at one end of the ground end cap 24 to position the insulating base 33. Screw-line patterns 342 are formed circumstantially on an external portion of the ground end cap 34. The patterns 342 of the ground end cap 34 are corresponding and match to the screw-line patterns provided on the metal end cap 31, such that the metal end cap 31, the signal connecting device 32, the insulating base 33 and the ground end cap 24 can be integrated together to form one unit.

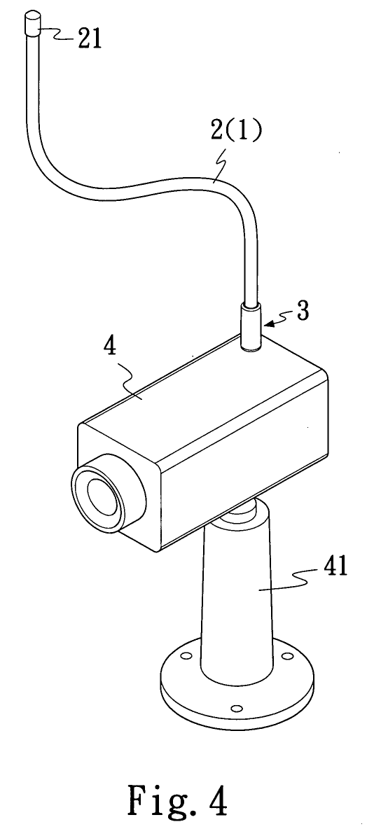

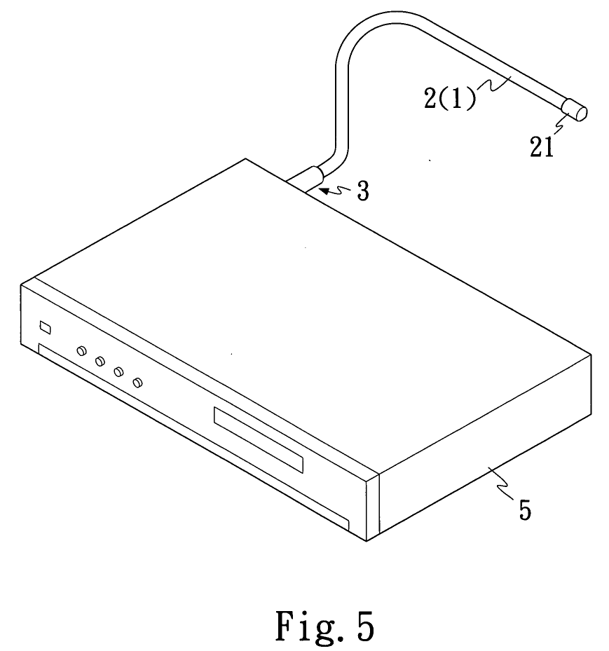

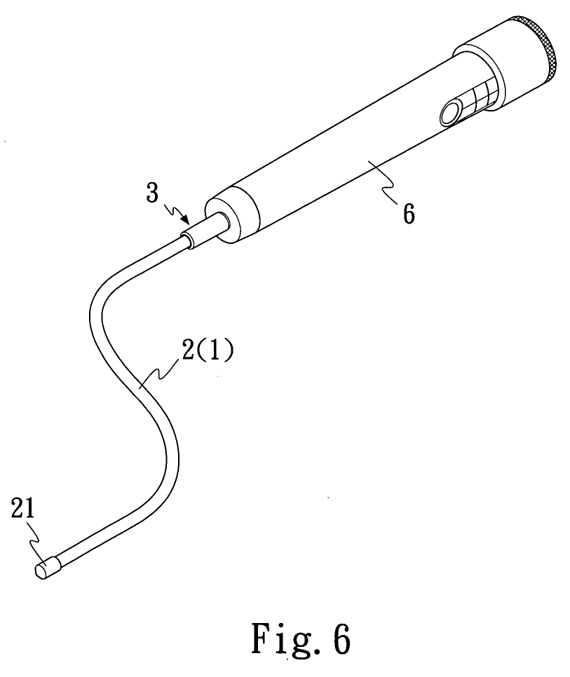

FIGS. 4-6 show how the flexible antenna of the present invention is utilized in various devices in accordance with preferred examples. The design of the present invention allows the metal tube 1 of the flexible antenna to be connected to an electronic device through the signal connector 3. FIG. 4 illustrates the flexible antenna of the present invention using on a wireless video device 4 positioned on a rotating unit 41. The image signals can be produced via the wireless video device 4. FIG. 5 shows the flexible antenna utilized on the signal connecting end (antenna) of the common radio 5. FIG. 6 illustrates the flexible antenna utilized on the signal output of the wireless microphone 6. The metal tube 1 of the flexible antenna comprises conductive property that can be used as a media for electronic wave transmission (receive or transfer). The property of the flexible antenna can sustain to pressure or force and be bent into a desired shape. The present invention provides a flexible antenna that can be confined into various designed shapes in accordance with different environmental conditions in order to fit the various space restrictions Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A flexible antenna, comprising
a flexible metal tube, which can sustain to an external force without being damaged by deforming into a corresponding curvy shape, wherein one end of the flexible metal tube can be connected to a predetermined electronic device via a signal connector, in order to facilitate wave transmission of the electronic device via the flexible metal tube; and
an insulating tube, covering an external surface of the flexible metal tube in order to avoid electrical connection between the flexible metal tube and an external conductors.

2. The flexible antenna of claim 1, wherein the insulating tube is a heat shrinkable insulating tube.

3. The flexible antenna of claim 1, wherein the flexible metal tube is formed by rolling a spring steel into a hollow tube with highly concentrated spirals.

4. The flexible antenna of claim 1, wherein the flexible metal tube is a serpentine tube.

5. The flexible antenna of claim 1, wherein an insulating end cap is provided on one end of the flexible metal tube, which is opposite to the end of the flexible metal tube with the signal connector.

6. The flexible antenna of claim 1, wherein the signal connector is a connector for coaxial cable.
